(19) United States
(12) Patent Application Publication
(10) Pub. No.: US 2026/0360583 A1
(43) Pub. Date: Nov. 12, 2026

(54) PRODUCTION OF RADIO ISOTOPES

(71) Applicant: PANTERA, Mol (BE)

(72) Inventors: Sébastien DE NEUTER, Mornimont (BE); Patrice JACQUET, Oleye (BE); Frédéric STICHELBAUT, Mazy (BE); Dominic MAERTENS, Dessel (BE); Willem LEYSEN, Mol (BE); Sven VAN DEN BERGHE, Verrebroek (BE); Samy BERTRAND, Ixelles (BE)

(21) Appl. No.: 19/135,861

(22) PCT Filed: Dec. 6, 2023
(86) PCT No.: PCT/EP2023/084635

§ 371 Date: Jun. 5, 2025

(30) Foreign Application Priority Data
Dec. 6, 2022 (EP) 22211687.3

(51) Int. Cl. G21G 1/10; G21G 1/06

(52) U.S. Cl. CPC G21G 1/10; G21G 1/06

(57) ABSTRACT

An irradiation station for the photonuclear production of radioisotopes from a target includes at least one beam line for inducing an electron beam and at least one irradiation pool. The irradiation station includes, submersed in the at least one irradiation pool, a beam converter component positioned at the end of the at least one beam line for converting the electron beam of the at least one beam line into photons, a target irradiation component for holding the target and positioned with respect to the beam converter component so as to, in operation, irradiate the target with said photons. Alternatively, a proton beam or deuterium beam may be introduced in the irradiation pool and protons or deuterium may be used directly for irradiating the target. Another alternative is that a deuterium beam may be introduced in the irradiation pool and neutrons converted therefrom can be used directly for irradiating the target.

### TECHNICAL FIELD OF THE INVENTION

The present invention relates to the field of production of radio-isotopes. More specifically, the present invention relates to a production facility and components thereof for the production of radio-isotopes, as well as to the use thereof and a corresponding method.

### BACKGROUND OF THE INVENTION

In order to secure the large-scale production of radioisotopes, such as for example 225Ac, new and efficient radioisotope production facilities are required.

U.S. Pat. No. 10,115,491 B2 describes an example of an apparatus for producing 99Mo from a plurality of 100Mo targets through a photo-nuclear reaction on the 100Mo targets. The apparatus is based on an electron linear accelerator, a converter, a target irradiation component and two coolant systems, i.e. one for the converter and one for the target irradiation component. Issues with such an isotope production facilities are the complex arrangements for cooling and the substantial irradiation damage that are occurring at the production facilities, as well as the significant down time when targets or other components need to be replaced or maintained.

Whether or not large scale production of radioisotopes will be able to follow the demand, will depend on the efficiency of the isotope production facilities.

Although a number of isotope production systems have been explored over the last tens of years, there is still a quest for efficient isotope production facilities.

### SUMMARY OF THE INVENTION

It is an object of the present invention to provide a good system and method for producing radioisotopes. It is an advantage of embodiments of the present invention that production of radio-isotopes may be obtained with high yield. It is a further advantage of embodiments of the present invention that systems and methods are provided for the production of radio-isotopes with low radio-active waste generation.

The above objective is accomplished by a method and apparatus according to the present invention.

In one aspect, the present invention relates to an irradiation station for the nuclear production of radioisotopes from a target, the irradiation station comprising
at least one beam line for inducing an electron beam, a proton beam or a deuterium beam,
at least one irradiation pool, during radioisotope production being filled with a water-based liquid, the at least one beam line entering or being present in the at least one irradiation pool,
the irradiation station furthermore comprising a target station, submersed in the at least one irradiation pool, comprising a target irradiation component for holding the target and positioned with respect to the beam line so as to, in operation, irradiate the target.

The at least one beam line may be configured for inducing an electron beam,
and the target station may comprise a beam converter component positioned at the end of the at least one beam line for converting the electron beam of the at least one beam line into photons, and the target irradiation component for holding the target may be positioned with respect to the beam converter component so as to, in operation, irradiate the target with said photons.

In one embodiment, the present invention thus relates to an irradiation station for the photonuclear production of radioisotopes from a target, the irradiation station comprising
at least one beam line for inducing an electron beam,
at least one irradiation pool, during radioisotope production being filled with a water-based liquid,
the at least one beam line entering or being present in the at least one irradiation pool,

The at least one beam line may be configured for inducing a deuterium beam, and the target station may comprise a beam converter component positioned at the end of the at least one beam line for converting the deuterium beam of the at least one beam line into neutrons, and the target irradiation component for holding the target may be positioned with respect to the beam converter component so as to, in operation, irradiate the target with said neutrons.
a beam converter component positioned at the end of the at least one beam line for converting the electron beam of the at least one beam line into photons, and
a target irradiation component for holding the target and positioned with respect to the beam converter component so as to, in operation, irradiate the target with said photons.

It is an advantage of embodiments of the present invention that cooling may be performed by the pool liquid. It is an advantage of embodiments of the present invention that the cooling capacity is already high, even based on non-forced convection. It is an advantage of embodiments of the present invention that they allow for a significant decrease in cooling configuration or design thereof.

Natural convection or boiling assisted convections may be used, which are cooling regimes that may inherently be used in the pool. It is an advantage of such cooling that large heat transfer is obtained, which may especially advantageous when the system is operated at temperatures more than 120 °C, e.g. when using lead shielding blocks.

In some embodiments, the at least one beam line may be entering the at least one irradiation pool. In some embodiments, the at least one beam line may be present in the at least one irradiation pool. Components, such as for example rastering magnet dipoles, quadrupoles or other components also can be in the pool. An accelerator also can be in the pool.

It is an advantage of embodiments of the present invention to provide irradiation stations that provide a large degree of flexibility. It is an advantage of embodiments of the present invention that allows easy access, in case of for example maintenance.

It is an advantage of at least some embodiments that at least part of the handling and/or maintaining of the system can be performed when the system is in operation or shortly thereafter by performing handling steps from an area positioned above the irradiation position.

It is an advantage of embodiments of the present invention that it provides options for easy removal, storage and dismantling of activated components under water and a reduction of handling of casks for waste transfers. It is a further advantage of embodiments of the present invention that systems and methods are provided for the production of radio-isotopes with reduced quantities of radio-active waste generation.

It is an advantage of embodiments of the present invention that it provides for a relatively easy modification and optimisation of the irradiation system.

It is an advantage of embodiments of the present invention that it combines aspects of cooling with aspects of local shielding, without the need for complex integration of cooling elements in the shielding elements.

It is an advantage of embodiments of the present invention that it allows for wide angle and direct visual feedback of the overall installation. The latter is for example in contrast with at least some of the state of the art systems wherein the irradiation position is encircled with a concrete structure. It is an advantage of embodiments of the present invention that it provides direct visibility of the target station, thus allowing a wide angle visual feedback of the overall installation, particularly during the moving of components under water through hands-on remote handling.

It is an advantage of embodiments of the present invention that the amount of radioactive activation of the local shielding and the surroundings is limited, resulting in a lower environmental cost when dismantling the infrastructure.

It is an advantage that replacement of the convertor or replacement of the target can be done in an efficient manner. It is an advantage of embodiments of the present invention that a high accessibility of the convertor and the irradiation area is obtained, allowing in less down time in case of issues and in less difficulties to replace the convertor, the target holder or the full target station.

It is to be noted that although the beam converter component and the target irradiation component are both cited as separate components, the present invention also relates to a single component performing both functions. The beam converter component may in some embodiments be omitted, e.g. if an external component performs the conversion action from an electron beam to a photon beam.

It is an advantage of embodiments of the present invention that the required size of the irradiation pool may be limited in size due to the use of one or more shielding elements at one or more sides of the target irradiation component.

According to some embodiments, the irradiation station may comprise a component for preventing short-lived isotopes from mixing in the liquid of the irradiation pool. The latter may for example be established by means of a suction line, e.g. close to one or more shielding elements, e.g. close to one or more local shielding elements. Such a suction line may for example be established at the inside of the shielding elements. Such a component, e.g. suction line, may be connected to a decay tank or decay loop. It is an advantage of embodiments of the present invention that the decay tank or decay loop can be small in size, as the required flow is low. It is an advantage that embodiments according to the present invention result in a serious reduction of potential short lived isotopes in the pool and consequently emissions.

According to some embodiments, the irradiation pool may be filled with water, although embodiments are not limited thereto and for example a mixture of water and boron could also be used or another combination resulting in a water-based liquid.

The irradiation station may comprise at least one shielding element submersed in the at least a first irradiation pool and being positioned between the target irradiation component and at least one wall of the at least one irradiation pool. It is an advantage of embodiments of the present invention that only a limited activation, preferably as small as possible, of the walls of the pool is present by neutrons, since these are absorbed by the water. The latter may for example be obtained by appropriately adjusting the size of the pool. Activation of the walls of the pools may be stopped by introducing one or more shielding elements between the target station and at least one wall of the at least one irradiation pool. These shielding elements may be outfitted with their own independent cooling circuits. Alternatively or in addition thereto, cooling may be performed by natural convection in the liquid or by boiling assisted convection. The shielding elements may be positioned at those position with high or highest radiation field in order to reduce their energy with the objective to have radiation below a threshold, e.g. the activation threshold, at the exit of the shielding.

The irradiation station may comprise one or more shielding components that can be handled separately from each other and from the target irradiation component.

The one or more shielding element may comprise one shielding element positioned between the target irradiation component and the wall positioned at the side of the target irradiation component opposite the beam converter component.

The irradiation station furthermore may comprise at least one hot cell in connection with the target irradiation component, for handling a target that can be loaded in the target irradiation component.

It is an advantage of embodiments of the present invention that handling, such as preparation of, the target can be performed easily and that the introduction of the target into the target irradiation component for accurately positioning the target in the irradiation beam can be performed in an efficient manner.

Where embodiments of the present invention refer to at least one hot cell in connection with the target irradiation component, such connection may be a fluidic connection. The connection between the hot cell and the target irradiation component, may be a piping system, such as for example small piping inside a stainless steel hose or in another hose, such as to obtain double vessel encapsulation. The hot cell may comprise or may be connected through one or more valves with the target irradiation component for controlling the transfer of the target material or a target capsule. The target capsule may be for example an underwater loaded container. Whereas in some embodiments one or more hot cells are used, the present invention also relates to systems wherein the target is at least partly handled and/or prepared in the irradiation pool.

The hot cell, or in other embodiments also the irradiation station, may comprise for example one or more of a pressure control system, a rinsing system, filling system, draining system, a water level control system, a radiolysis product control and/or evacuation system, a target integrity monitoring system, a hot cell integrity monitoring system, etc.

The connection between the hot cell and the target irradiation component may be adapted for transferring a gaseous target material, a gaseous target capsule, a liquid target material, a liquid target capsule and/or a solid target capsule between the hot cell (160) and the target irradiation component. It is an advantage of embodiments of the present invention that an efficient transfer of target material can be obtained between the target irradiation component at the irradiation position and the hot cell for handling the target material.

In some embodiments where a target capsule is transferred, the system may be equipped with a mechanism to lock the capsule in the correct position. The transfer of the capsule may for example then also be obtained by handling the capsule from the top side of the pool and using tools, for example handled from the top side of the pool.

It is an advantage of embodiments of the present invention that gaseous as well as liquid and solid target materials can be handled efficiently.

The connection between the target irradiation component and the cot cell may comprise a capillary tubing for connecting the target irradiation component with the hot cell and for transferring liquid target material between the target irradiation component and the hot cell.

The capillary tubing may be configured for allowing capillary transport of the target.

The beam converter component and target irradiation component may also be integrated into a single component and the target irradiation component may double as the beam converter component.

Handling means may be positioned above the at least one irradiation pool for handling components of the irradiation station in and/or outside of the at least one irradiation pool. The handling means may comprise for example pool tools for performing actions in or with respect to the pool. The handling means may for example also comprise a crane or bridge for lifting and or moving components of the irradiation station in the at least one irradiation pool and/or outside the at least one irradiation pool. It is to be noted that one of the possible actions may be the removal of some or all activated components from the beam line, the converter and/or the target station remotely under water, e.g. of all activated components thereof, after which access to the beam line for hands on installation of new components can become possible by lowering the water level.

The volume of the first irradiation pool may be at least 50000 liter, e.g. at least 75000 liter, e.g. at least 100000 liter. The first irradiation pool may be fluidically coupled to an auxiliary pool for storing, dismantling, maintaining or performing operations on activated components, the auxiliary pool being adapted for being able to be emptied independently of the first irradiation pool.

Each side wall of the pool may be at least 1 m, e.g. at least 1.5 m, e.g. at least 2 m away from the target irradiation component. Where reference is made to a side wall of the pool, reference is made to walls at the side of the target irradiation component, different from the bottom side, the bottom side being defined by the side being below the target irradiation component with respect to the direction of gravity. In some embodiments, the bottom wall of the target irradiation component may be at least 1 m, e.g. at least 1.5 m, e.g. at least 2 m away from the target irradiation component.

During irradiation of the target, at least part of the water in the irradiation pool may be not subject to forced cooling circulation. Where reference is made to at least part of the water, reference is made to at least 30%, e.g. at least 50% of the water in the pool. Where reference is made to forced circulation of the water, reference is made to circulation of the water induced by pumping of the water.

The at least one irradiation beam line may be part of an accelerator. According to embodiments the beam line may be adapted for generating an electron beam.

The irradiation station may furthermore comprise at least a second irradiation pool, during radioisotope production being filled with a water-based liquid, at least one beam line entering the at least a second irradiation pool, the irradiation station furthermore comprising a second target station, submersed in the at least second irradiation pool, comprising a second beam converter component positioned at the end of the at least one beam line entering the second irradiation pool for converting the electron beam into photons, and a second target irradiation component for holding the target and positioned with respect to the second beam converter component so as to, in operation, irradiate the target with said photons. The irradiation station may be configured for providing redundancy and for guaranteeing a high ratio of production to down time by allowing alternatingly radiation in the target irradiation components in the different irradiation pools.

Alternatively or in addition thereto, the system could also be equipped for simultaneously irradiating targets in different irradiation pools.

In some embodiments, additional beam lines may be introduced into the at least one pool, with the additional beam lines either converging onto a single converter component or each possessing their own converter component and for which the resulting gamma rays are directed at a single target station or each possessing their own target station.

In another aspect, the present invention also relates to a method of producing radioisotopes from a target, the method comprising
inducing at least one electron beam and allowing the electron beam to enter at least one irradiation pool,
the method further comprising, in the irradiation pool,
converting the electron beam into a photon beam, and
irradiating the target with said photons.

Further steps of the method may correspond with the functionalities performed by standard or optional components of the irradiation station as described in the first aspect.

In still another aspect, the present invention relates to the use of an irradiation station as described in the first aspect.

Although there has been constant improvement, change and evolution of devices in this field, the present concepts are believed to represent substantial new and novel improvements, including departures from prior practices, resulting in the provision of more efficient, stable and reliable devices of this nature.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 is a schematic representation of an irradiation station for the photonuclear production of radioisotopes from a target according to an embodiment of the present invention.

FIG. 2 is a schematic representation of an irradiation station with two irradiation pools, according to an embodiment of the present invention.

In the different figures, the same reference signs refer to the same or analogous elements.

### DESCRIPTION OF ILLUSTRATIVE EMBODIMENTS

The present invention will be described with respect to particular embodiments and with reference to certain drawings, but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention. For example, the size of the auxiliary pool compared to the size of the first and of the second irradiation pool is not in proportion. Furthermore, the relative positions of the different components in the schematic drawings are nor representative for their actual positions.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. The term “comprising” therefore covers the situation where only the stated features are present and the situation where these features and one or more other features are present. The word “comprising” according to the invention therefore also includes as one embodiment that no further components are present. Thus, the scope of the expression “a device comprising means A and B” should not be interpreted as being limited to devices consisting only of components A and B. It means that with respect to the present invention, the only relevant components of the device are A and B.

Similarly, it is to be noticed that the term “coupled”, also used in the claims, should not be interpreted as being restricted to direct connections only. The terms “coupled” and “connected”, along with their derivatives, may be used. It should be understood that these terms are not intended as synonyms for each other. Thus, the scope of the expression “a device A coupled to a device B” should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

The invention will now be described by a detailed description of several embodiments of the invention. It is clear that other embodiments of the invention can be configured according to the knowledge of persons skilled in the art without departing from the technical teaching of the invention, the invention being limited only by the terms of the appended claims.

Generally, the present invention relates to an irradiation station for the production of isotopes from a target, the irradiation station comprising
at least one beam line for inducing an electron beam, a proton beam or a deuterium beam,
at least one irradiation pool, during isotope production being filled with a water-based liquid,
the at least one beam line entering or being positioned in the at least one irradiation pool,
the irradiation station furthermore comprising a target station, submersed in the at least one irradiation pool, comprising
a target irradiation component for holding the target and positioned so as to, in operation, irradiate the target.

In some embodiments, the station is for the production of radio-isotopes and the beam line is for inducing an electron beam. The target station then comprises a beam converter component positioned at the end of the at least one beam line for converting the electron beam into photons and the target irradiation component for holding the target is positioned so as to position the target into the generated photons. In other embodiments, a proton beam and deuterium beam is thus introduced in the irradiation pool and the protons or deuteriums are directly used for irradiating the target.

In some embodiments of the first aspect, the present invention thus relates to an irradiation station for the photonuclear production of radioisotopes from a target. According to embodiments, the irradiation station comprises at least one beam line for inducing an electron beam, and at least one irradiation pool, during radioisotope production being filled with a water-based liquid. The at least one beam line thereby is entering or positioned in the at least one irradiation pool. In some embodiments, the beam line thereby may enter the at least one irradiation pool via a wall or floor of the pool. In some embodiments, the beam line thereby may enter via a top surface of the liquid in the pool. The beam line may in some embodiments be bent a last time in the pool room in which the irradiation pool is positioned. The irradiation station furthermore comprises a target station, submersed in the at least one irradiation pool, comprising a beam converter component positioned at the end of the at least one beam line for converting the electron beam into photons, and a target irradiation component for holding the target and positioned with respect to the beam converter component so as to, in operation, irradiate the target with said photons.

In some embodiments of the first aspect, the present invention thus relates to an irradiation station for the production of radioisotopes from a target, wherein the irradiation station comprises at least one beam line for inducing a deuterium beam, and at least one irradiation pool, during production being filled with a water-based liquid. The at least one beam line thereby is entering or positioned in the at least one irradiation pool. In some embodiments, the beam line thereby may enter the at least one irradiation pool via a wall or floor of the pool. In some embodiments, the beam line thereby may enter via a top surface of the liquid in the pool. The beam line may in some embodiments be bent a last time in the pool room in which the irradiation pool is positioned. The irradiation station furthermore comprises a target station, submersed in the at least one irradiation pool, comprising a beam converter component positioned at the end of the at least one beam line for converting the deuterium beam into neutrons and a target irradiation component for holding the target and positioned with respect to the beam converter component so as to, in operation, irradiate the target with said neutrons.

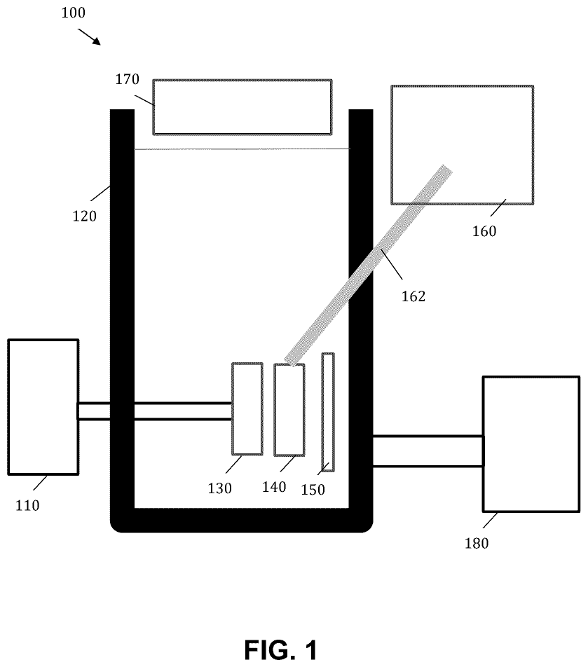

Further by way of illustration, embodiments of the present invention not being limited thereto, standard and optional features of an irradiation station will further be described with reference to the drawings. FIG. 1 illustrates a schematic representation of an irradiation station 100 for producing isotopes from a target. The system or corresponding method for producing radioisotopes may for example be illustrated for the production of Actinium isotopes from Radium targets, but embodiments are not restricted by the particular isotope to be produced. The system and method may for example—but not limited to—be suitable for producing Sc-47, Cu-67, Cs-131, Tb-155, Ra-225, or Ac-225, preferably Ac-225. The system may be especially suitable for producing radioisotopes by photonuclear production.

In the schematic example shown in FIG. 1, a beam line 110 for inducing an electron beam is provided. The beam line 110 also may comprise a beam shaper. The beam line 110 may be or may be part of an accelerator. Particular details of the beam line may be as known by the skilled person. In the irradiation station 100, the beam line 110 enters at least one irradiation pool 120 filled with a water-based substance. The at least one irradiation pool 120 may for example be filled with water, or with water with one or more added substances. In some examples, for example boron may be added to the pool water. The irradiation pool 120 may for example have concrete walls, although embodiments are not limited thereto. The size of the pool typically may be sufficiently large to encompass a target station. The volume of the first irradiation pool 120 may be at least 50000 liter, e.g. at least 75000 liter, e.g. at least 100000 liter. The first irradiation pool 120 may be fluidically coupled to an auxiliary pool for storing, dismantling, maintaining or performing operations on activated components, the auxiliary pool 180 being adapted for being able to be emptied independently of the first irradiation pool 120.

Such an auxiliary pool 180 may be adapted for performing waste handling, container handling, cutting, etc.

Each side wall of the first irradiation pool 120 may be at least 1 m, e.g. at least 1.5 m, e.g. at least 2 m away from a target irradiation component. Where reference is made to a side wall of the pool, reference is made to walls at the side of the target irradiation component, different from the bottom side, the bottom side being defined by the side being below the target irradiation component with respect to the direction of gravity. In some embodiments, the bottom wall of the target irradiation component may be at least 1 m, e.g. at least 1.5 m, e.g. at least 2 m away from the target irradiation component. In one embodiment, the pool may have a volume between 2×2×3 m³ and 7×7×12m³, e.g. between 2×2×4 m³ and 6×6×10 m³ such as for example 4×4×4 m³, but embodiments are not limited thereto.

During irradiation of the target, at least part of the water in the irradiation pool may be not subject to forced cooling circulation. Where reference is made to at least part of the water, reference is made to at least 30%, e.g. at least 50% of the water in the pool. Where reference is made to forced circulation of the water, reference is made to circulation of the water induced by pumping of the water. In some embodiments, the pool water may be used at least partly for cooling a converter or an irradiated target material, but dedicated cooling systems also may be present, also submersed in the irradiation pool.

The irradiation station 100 may in some embodiments also comprise a water conditioning pool, one or more filters or a water conditioning converter. In one particular embodiment, the system also may comprise a Ra recovery system, a dump tank, a distillation column, or similar components.

The irradiation station 100 also may comprise handling means 170 positioned above the at least one irradiation pool 120 for handling components of the irradiation station 120 in and/or outside of the at least one irradiation pool 120. The handling means 170 may comprise for example pool tools for performing actions in or with respect to the pool. The handling means 170 may for example also comprise a crane or bridge for lifting and or moving components of the irradiation station in the at least one irradiation pool and/or outside the at least one irradiation pool. It is to be noted that one of the possible actions may be the removal of some or all activated components from the beam line, the converter and/or the target station remotely under water, e.g. of all activated components thereof, after which access to the beam line for hands on installation of new components can become possible by lowering the water level. The handling means 170 may for example be positioned in a pool room that is positioned above the irradiation pool 120. Such a room also may be conditioned, e.g. using a conditioning system. The pool room may be the room from where handling may be performed. According to at least some embodiments, the irradiation station 100 may be adapted for allowing visual inspection.

The irradiation pool 120 typically is large enough to allow for submersion of a target station 101. In some embodiments, the target station 101 comprises a beam converter component 130 for converting the electron beam of the beam line into photons. The beam converter component 130 typically is positioned at the end of the beam line 110. The beam converter component 130 may have a dedicated cooling circuit and/or shielding elements. Further features and advantages of the beam converter component 130 may be as known by the person skilled in the art. The beam converter may be an electron-gamma converter as known in prior art.

In the target station 101, also a target irradiation component 140 is provided. The target irradiation component 140 is configured for receiving the target material. According to embodiments of the present invention, the target material may be gaseous target material, liquid target material or solid target material positioned directly in the target irradiation component 140 or in a local holder or may be a gaseous target capsule, a liquid target capsule or a solid target capsule. E.g. in the case of capsules, handling of the target capsules may be done using dedicated or general handling means provided in the irradiation station 100.

In one embodiment, the system is adapted for using a fluid, e.g. liquid, target. A dedicated liquid target module may be present in the target irradiation component 140. Such a liquid target module in the target irradiation component 140 may be connected, e.g. by tubing such as capillary tubing, with a preparation stage, which may be positioned outside the irradiation pool 120. Fluid target, e.g. liquid target, may be loaded through the tubing. The preparation stage may be a hot cell 160. The hot cell 160 may in some embodiments comprise one or more of the following features: features for pressure control, features for filling, draining or rinsing, features for controlling the water level, features of controlling and or evacuation of radiolysis products, features to perform capillary transport, features for capsule transport, features for checking and/or monitoring capsule integrity. In the hot cell 160, also systems for controlling Radon and more generally controlling radiochemistry may be present. The system may also comprise a capillary tube recovery equipment.

The connection between the target irradiation component 140 and the preparation stage, e.g. hot cell, may run through the pool, over the pool, etc.

According to embodiments of the present invention, the submersed target station also may comprise one or more local shielding elements 150. In this way, e.g. walls of the irradiation pool may be less or not subject to activation. The local shielding may be made of lead or any other suitable material for absorbing radiation.

As indicated above, alternatively, the system may be adapted for using a deuterium beam incident on a deuterium-neutron convertor for generating a neutron beam. In this way, a beam of fast-neutrons that are forward-oriented can be obtained. This allows to produce neutron-induced reactions efficiently.

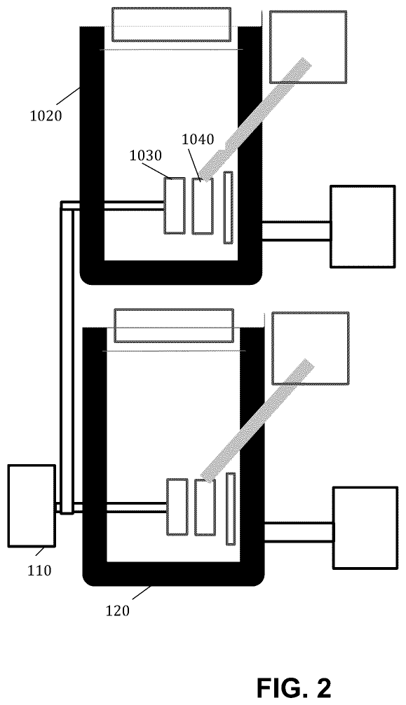

In another example, the irradiation station comprises more than one irradiation pool with submersed components, as illustrated in FIG. 2. In such an irradiation station, a second target station is present submersed in a second irradiation pool 1020. In the example shown, the second target station comprises a second beam converter component 1030 positioned at the end of the at least one beam line entering the second irradiation pool 1020 for converting the electron beam into photons, and a second target irradiation component 1040 for holding the target and positioned with respect to the second beam converter component so as to, in operation, irradiate the target with said photons. The irradiation station may be configured for providing redundancy and for guaranteeing a high ratio of production to down time by allowing alternatingly radiation in the target irradiation components in the different irradiation pools. Alternatively or in addition thereto, the system could also be equipped for simultaneously irradiating targets in different irradiation pools.

In some embodiments, additional beam lines may be introduced into the at least one pool, with the additional beam lines either converging onto a single converter component or each possessing their own converter component and for which the resulting gamma rays are directed at a single target station or each possessing their own target station.

In another aspect, the present invention also relates to a method of producing radioisotopes from a target, the method comprising inducing at least one electron beam, proton beam or deuterium beam and allowing the electron beam to enter at least one irradiation pool. The method further comprises in some embodiments, in the irradiation pool, converting the electron beam into a photon beam. In other embodiments, the proton beam or deuterium beam is directly used. The method also comprises
irradiating the target with said photons, protons, deuteriums or neutrons, stemming directly or after conversion from the at least one beam. Further steps of the method may correspond with the functionalities performed by standard or optional components of the irradiation station as described in the first aspect.

In still another aspect, the present invention relates to the use of an irradiation station as described in the first aspect.

It is to be understood that although preferred embodiments, specific constructions and configurations, as well as materials, have been discussed herein for devices according to the present invention, various changes or modifications in form and detail may be made without departing from the scope of this invention. Steps may be added or deleted to methods described within the scope of the present invention.

1-17. (canceled)

18. An irradiation station for the nuclear production of radioisotopes from a target, the irradiation station comprising:
at least one beam line for inducing an electron beam, a proton beam or a deuterium beam,
at least one irradiation pool, during radioisotope production being filled with a water-based liquid,
the at least one beam line entering or being present in the at least one irradiation pool,
the irradiation station furthermore comprising a target station, submersed in the at least one irradiation pool, comprising:
a target irradiation component for holding the target and positioned with respect to the beam line so as to, in operation, irradiate the target.

19. The irradiation station according to claim 18, wherein the at least one beam line is configured for inducing an electron beam, and
wherein the target station comprises a beam converter component positioned at the end of the at least one beam line for converting the electron beam of the at least one beam line into photons, and the target irradiation component for holding the target is positioned with respect to the beam converter component so as to, in operation, irradiate the target with said photons.

20. The irradiation station according to claim 18, wherein the at least one beam line is configured for inducing a deuterium beam, and
wherein the target station comprises a beam converter component positioned at the end of the at least one beam line for converting the deuterium beam of the at least one beam line into neutrons, and the target irradiation component for holding the target is positioned with respect to the beam converter component so as to, in operation, irradiate the target with said neutrons.

21. The irradiation station according to claim 18, wherein the irradiation station comprises at least one shielding element submersed in the at least a first irradiation pool and being positioned between the target irradiation component and at least one wall of the at least one irradiation pool.

22. The irradiation station according to claim 18, wherein the at least one shielding element comprises one or more shielding components that can be handled separately from each other and from the target irradiation component.

23. The irradiation station according to claim 18, wherein the irradiation station furthermore comprises at least one hot cell in connection with the target irradiation component, for handling a target that can be loaded in the target irradiation component.

24. The irradiation station according to claim 23, wherein the connection between the hot cell and the target irradiation component is adapted for transferring a gaseous target material, a gaseous target capsule, a liquid target material, a liquid target capsule and/or a solid target capsule between the hot cell and the target irradiation component.

25. The irradiation station according to claim 24, wherein the connection between the target irradiation component and the hot cell comprises a capillary tubing for connecting the target irradiation component with the hot cell and for transferring liquid target material between the target irradiation component and the hot cell.

26. The irradiation station according to claim 18, wherein handling means are positioned above the at least one irradiation pool for handling components of the irradiation station in and/or outside of the at least one irradiation pool.

27. The irradiation station according to claim 18, wherein the volume of the pool is at least 50000 litre.

28. The irradiation station according to claim 18, wherein the first irradiation pool is fluidically coupled to an auxiliary pool for storing, dismantling, maintaining or performing operations on activated components, the auxiliary pool being adapted for being able to be emptied independently of the first irradiation pool.

29. The irradiation station according to claim 18, wherein each side wall of the pool is at least 1 m away from the target irradiation component.

30. The irradiation station according to claim 18, wherein the at least one irradiation beam line is part of an accelerator.

31. The irradiation station according to claim 18, the irradiation station comprising at least a second irradiation pool, during radioisotope production being filled with a water-based liquid,
the at least one beam line entering the at least a second irradiation pool, the irradiation station furthermore comprising a second target station, submersed in the at least second irradiation pool, comprising:
a second beam converter component positioned at the end of the at least one beam line entering the second irradiation pool for converting the electron beam into photons,
a second target irradiation component for holding the target and positioned with respect to the second beam converter component so as to, in operation, irradiate the target with said photons.

32. The irradiation station according to claim 18, wherein additional beam lines are introduced into the at least one pool, with the additional beam lines either converging onto a single converter component or each possessing their own converter component and for which the resulting gamma rays are directed at a single target station or each possessing their own target station.

33. A method of producing radioisotopes from a target, the method comprising inducing at least one electron beam, proton beam or deuterium beam and allowing the electron beam, proton beam or deuterium beam to enter at least one irradiation pool,
the method further comprising, in the irradiation pool,
irradiating the target with photons induced by electrons of said electron beam, with protons from said proton beam, with deuteriums from said deuterium beam or with neutrons derived from said deuterium beam.

34. Use of an irradiation station according to claim 18 for producing radioisotopes.
